(19) United States
(12) Patent Application Publication
(10) Pub. No.: US 2018/0173074 A1
(43) Pub. Date: Jun. 21, 2018

(54) BISTABILITY ENHANCEMENT IN TOTAL INTERNAL REFLECTION IMAGE DISPLAYS

(71) Applicant: CLEARink Displays, Inc, Fremont, CA (US)

(72) Inventors: Xiaojia Zhang, Fremont, CA (US); Thomas Johansson, Coquitlam (CA); Bram Sadlik, Vancounver (CA)

(73) Assignee: CLEARink Displays, Inc, Fremont, CA (US)

(21) Appl. No.: 15/757,115

(22) PCT Filed: Aug. 31, 2016
(86) PCT No.: PCT/US16/49654

§ 371 Date: Mar. 2, 2018

Related U.S. Application Data
(60) Provisional application No. 62/213,344, filed on Sep. 2, 2015.

(51) Int. Cl. G02F 1/167; G02F 1/1335; G02F 1/1339; G02F 1/133

(52) U.S. Cl. CPC G02F 1/167; G02F 1/1336; G02F 1/133514; G02F 2202/022; G02F 1/13306; G02F 2001/133616; G02F 2202/09; G02F 1/13394

(57) ABSTRACT

Total internal reflection image displays are equipped with a bistability enhancement particle interaction layer. The bistability enhancement layer imparts bistability in the display at 0V or power off. The bistability enhancement layer may hold particles near the surface in the evanescent wave region at the front electrode at 0V or power off to retain a dark state image. The particle interaction layer may hold particles near the surface of the rear electrode at 0V or power off to retain a bright state image. Control of particle density improves bistability.

The disclosure claims priority to the filing date of U.S. Provisional Application No. 62/213,344, filed Sep. 2, 2015, the specification of each of which is incorporated herein in its entirety.

### FIELD

This application generally relates to reflective image displays. In particular the disclosure relates to achieving bistability in total internal reflection image displays.

### BACKGROUND

Light modulation in total internal reflection (TIR) image displays may be controlled by movement of at least one of a plurality of light absorbing electrophoretically mobile particles in a low refractive index medium. The particles may be moved into and out of the evanescent wave region at the surface of a high refractive index front sheet comprising convex protrusions under an applied voltage across the electrophoretic medium. The particles may have either a positive or negative charge with a single optical characteristic. A first optical state of the display may be formed when the particles enter the evanescent wave region and frustrate TIR where incident light rays may be absorbed by the mobile particles (referred to as the dark state). A second optical state may be displayed when the particles are moved out of the evanescent wave region towards a rear electrode where light rays may be totally internally reflected to form a light or bright state. The display may comprise an optional second plurality of particles of a second color and opposite charge polarity to the first plurality of particles and capable of forming a third optical state. Driving pixels in a controlled manner to various optical states may create an image to display information to a viewer.

The image exhibits bistability if the image can be held for a period after the power to the display is turned off. Bistability (interchangeably, image stability) extends battery life and decreases energy costs during operation. Bistability may also further extend the display life and reduce maintenance and replacement costs. These are some key attributes for the adoption of TIR image displays in commercial and single user applications. There is a need in the art to increase bistability.

### BRIEF DESCRIPTION OF DRAWINGS

These and other embodiments of the disclosure will be discussed with reference to the following exemplary and non-limiting illustrations, in which like elements are numbered similarly, and where:

FIG. 1 depicts a cross-section of a TIR image display with a bistability enhancing layer according to one embodiment of the disclosure;

FIG. 2 is a graphical representation of a TIR image display with a bistability enhancing layer during switching; and

FIG. 3 schematically illustrates an exemplary system for implementing an embodiment of the disclosure.

### DETAILED DESCRIPTION

The disclosed embodiments generally relate to a method, system and apparatus to provide image bistability. In one embodiment, an apparatus comprising a bistability enhancement layer is disclosed. The disclosed embodiments enhance bistability and optical performance while maintaining switching characteristics when the power is on. The bistability enhancement layer may does not substantially affect the display's speed or switching performance while the device is powered.

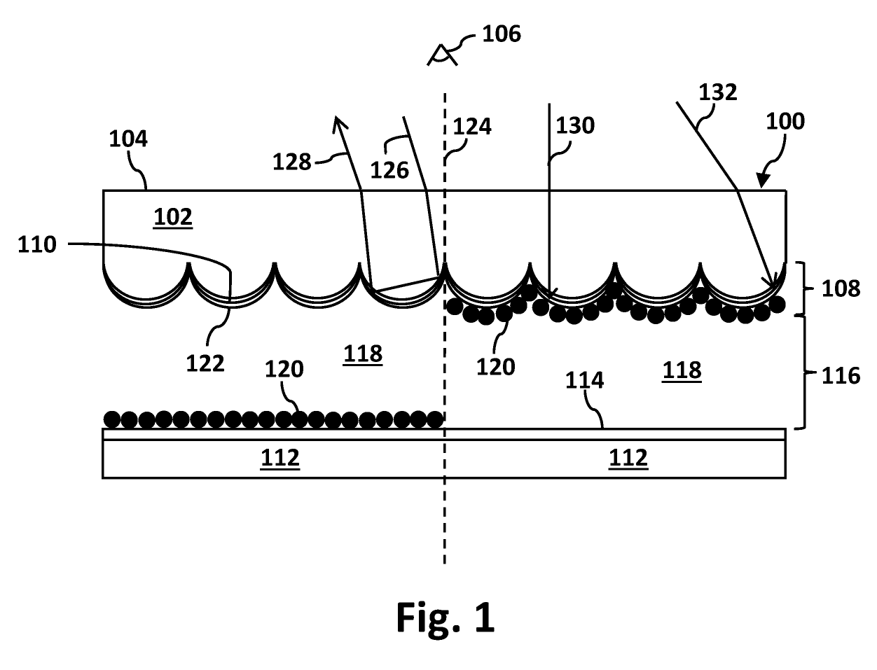

FIG. 1 depicts a cross-section of a TIR image display with a bistability enhancing layer according to one embodiment of the disclosure. Display 100 in FIG. 1 comprises a continuous, transparent front sheet (interchangeably, outward sheet) 102 with an outward surface 104 facing viewer 106. Front sheet 102 may comprise one or more of a polymer or glass. Sheet 102 further comprises a plurality of convex protrusions 108 on the inward surface. The convex protrusions may comprise one or more of beads or hemi-beads, or in the shape of beads or hemi-beads or in the shape of hemispherical protrusions as depicted in FIG. 1. At least one of the convex protrusions may comprise a polymer. The convex protrusions may be arranged closely together to form an inwardly projecting monolayer having a thickness approximately equal to the diameter of one of the protrusions. The plurality of the protrusions may be comprised of protrusions of various sizes. Each one of the protrusions may touch all of the protrusions immediately adjacent to that one protrusion. Minimal interstitial gaps or no gaps may remain between adjacent protrusions. In an exemplary embodiment sheet 102 may have a refractive index greater than about 1.6. Sheet 102 with plurality of convex protrusions 108 may be manufactured by the techniques of embossing, extrusion or other similar method or a combination thereof. Regardless of the design, the protrusions may be capable of TIR and may be used interchangeably in TIR-based displays.

Display 100 in FIG. 1 may further comprise a transparent front electrode 110 located on the surface of the array 108 of convex protrusions. Front electrode layer 110 may be comprised of one or more of indium tin oxide (ITO), an electrically conducting polymer such as BAYTRON P™ or conductive nanoparticles, metal nanowires, graphene or other conductive carbon allotropes or a combination of these materials dispersed in a substantially transparent polymer.

Display 100 may further comprise a rear support sheet 112. The inward surface of sheet 112 is shown with rear electrode layer 114. Rear electrode 114 may comprise one or more of a TFT array, patterned direct drive array or a passive matrix array of electrodes. An optional dielectric layer(s) (not shown) may be located on top of the front electrode layer 110 or the rear electrode layer 114 or both the front and rear electrode layers. The optional dielectric layer(s) may each have a thickness of at least 80 nanometers. In an exemplary embodiment, the thickness is about 80-200 nanometers. The optional dielectric layers may comprise one or more of a polymer or glass. In an exemplary embodiment the dielectric layer may comprise parylene. In other embodiments the dielectric layer may comprise a halogenated parylene. In an exemplary embodiment the dielectric layer may comprise polyimide. In other embodiments the dielectric layer may comprise SiO₂, fluoropolymers, polynorbornenes or hydrocarbon-based polymers lacking polar groups. The optional dielectric layers on the front electrode or rear electrode or both the front and rear electrode layers may each have a thickness of at least 80 nanometers. In an exemplary embodiment, the thickness is about 80-200 nanometers. In some embodiments the dielectric layers may comprise pin holes.

Cavity 116 is formed by the front sheet 102 and rear sheet 112 and may include medium 118. Medium 118 may be air or a liquid. In some embodiments, medium 118 may be a hydrocarbon. In other embodiments, medium 118 may be a fluorinated hydrocarbon or a perfluorinated hydrocarbon. Medium 118 may be transparent. Medium 118 may define a liquid with a refractive index less than about 1.4. In an exemplary embodiment the refractive index of medium 118 is less than the refractive index of outer sheet 102. In an exemplary embodiment, medium 118 may be Fluorinert™.

Display 100 in FIG. 1 may further comprise a plurality of light absorbing particles 120 suspended within medium 118. Particles 120 may comprise a positive or negative charge polarity. The particles may be a dye or pigment or a combination thereof. The particles may comprise one or more of an organic material or an inorganic material. Medium 118 may further comprise a second plurality of particles (not shown in FIG. 1). The second plurality of particles may comprise a charge polarity or may be weakly charged or uncharged. The second plurality of particles may have at least one particle having a charge polarity opposite of the charge polarity of the first plurality of particles. The second plurality of particles may be one or more of light absorbing or light reflecting. The second plurality of particles may be a dye or pigment or a combination thereof. The second plurality of particles may comprise one or more of an organic material or an inorganic material. Medium 118 may further comprise of one or more of a dispersant, charging agent, surfactant, flocculating agent, viscosity modifier or a polymer.

Display 100 may further comprise a voltage bias source (not shown in FIG. 1). The bias source may apply a voltage bias across medium 118 in cavity 116 to electrophoretically move at least one particle of a first plurality of particles 120. Bias source may additionally move at least one particle of an optional second plurality of particles. The bias source may be used to move the plurality of particles to the front electrode 110 or rear electrode 114 or anywhere in cavity 116 between the front electrode 110 and rear electrode 114.

In one embodiment, display 100 further includes a bistability enhancement layer 122. The bistability enhancement layer may be located, directly or indirectly, over front electrode layer 110 such that the bistability layer is between layer 110 and medium 118. A second bistability enhancement layer may also be added on top the rear electrode layer 114 (not shown in FIG. 1) between layer 114 and medium 118. Bistability enhancement layer 122 is a layer that may improve bistability in the display while maintaining the switching performance of the display.

The surface properties of layer 122 may be tuned to control the attraction between the surface of layer 122 and the electrophoretically mobile particles 120. This may also be referred to as the holding strength of layer 122. Molecules may be attached or bound to one or more of the front electrode layer 110 or rear electrode layer 114 to create a bistability enhancement layer. Layer 122 may comprise pendant groups of varying electronegativity. In some embodiments, some molecules used to create bistability enhancement layer may have pendant groups comprised of hydrocarbons. In some embodiments the bistability enhancement layer may comprise halogenated hydrocarbons. The halogenated hydrocarbons may comprise one or more of fluorine, chlorine or bromine atoms. In other embodiments some pendant groups of the bistability enhancement layer may comprise of varying levels of electron delocalization such as one or more of benzyl, thiophene, pyrrole, fullerene or anthracene groups or other groups with extended electronic delocalization. In other embodiments, some pendant groups of the bistability enhancement layer may be capable of hydrogen bonding; such as amines, thiols, hydroxyls or carboxylic acids. In other embodiments some groups may be ionic and charged such as quartenary amines or alkoxides. The pendant groups described herein to create the bistability enhancement layer may be covalently bound to the front electrode layer 110. In an exemplary embodiment, the pendant groups may be one or more of organosilazane or organosilane-based. In other embodiments, one or more of organosilazanes or organosilanes may be covalently bound to one or more of an ITO-based front electrode or rear electrode layer.

In some embodiments, display 100 in FIG. 1 may comprise a dielectric layer that may also act as the bistability enhancement layer 122. The dielectric layer may be one or more of an inorganic material or an organic material. For example, SiO₂ may also be used as both. The hydroxyl —OH sites on the surface of SiO₂ are polar and may be employed to interact with the surface of particles 120. The hydroxyl —OH groups on the surface of SiO₂ may be converted to alkoxide groups such as —O⁻Na⁺. The properties of the SiO₂ layer may be tuned by reaction with acids or bases.

In some embodiments, the dielectric layer may have chemically active sites where other molecules may be covalently bound to the surface of the dielectric layer to create layer 122 to modify the surface properties. For example, SiO₂ may be used as a dielectric layer as molecules may be bound to the free Si—OH sites on the surface. The dielectric layer may be of the parylene class of polymers. Certain substituted parylene coatings may be used that have chemically reactive sites where molecules may be covalently bound to the surface. Parylene-based coatings may preferably be used as they tend to create uniform, pinhole free films. In an embodiment, parylene A may be used which has one amine group per repeat unit in the backbone. In another embodiment, parylene AM may be used which has a methylene amine group in the repeat unit in the backbone of the polymer. In another embodiment, parylene H may be used which has a formyl group in the repeat unit in the backbone of the polymer. In other embodiments, parylene X may be used which has a cross-linkable hydrocarbon site in the backbone of the polymer.

In some embodiments, a porous SiO₂ layer may be located on top of one or more of the front electrode layer 110 or rear electrode layer 114 to act as an anchor layer to attach molecules to act as a particle interaction layer. The anchor layer may be used to attach molecules to create a bistability enhancement layer that typically may not be able to be attachable to the electrode layer. In some embodiments a thin SiO₂ layer may be applied over the electrode layer to attach one or more of organosilazane or organosilane-based pendant groups. A porous SiO₂ layer may not act as a dielectric layer if the application does not require a dielectric layer or if a dielectric layer comprising pin holes is required.

In other embodiments a surfactant may be added to medium 118 that may have an affinity to one or more of the front or rear electrode layers or to one or more of an optional front or rear dielectric layer. For example, mixing fluorosurfactant from Dupont's Capstone series of fluorosurfactants such as Capstone FS-22, Capstone FS-83, or Capstone FS-3100 or from Pilot Chemical's Masurf series of SCT Fluoroaliphatic Surfactant, Masurf FS-2800, Masurf FS-2900, with medium 118. The fluorosurfactant may migrate to render the dielectric coating surface fluorinated.

In other embodiments, surfactants comprising desirable reactive functional groups may be combined with the dielectric coating formulation. The surfactant may substantially move to the coating surface during dielectric coating formation and may be covalently bonded into the coating matrix during the dielectric coating curing step. In an exemplary embodiment, the surfactants may be halogenated with one or more of fluorine, bromine or chlorine atoms.

In one embodiment, a layer of SiO₂ is used for an optional dielectric layer and the bistability enhancement layer on both the front and rear electrodes. In another embodiment, a layer of SiO₂ is used for an optional dielectric layer and the bistability enhancement layer on the front electrode only. In another embodiment, a layer of SiO₂ is used for an optional dielectric layer and the bistability enhancement layer on the rear electrode only.

In some embodiments, a layer of SiO₂ may be used for the optional dielectric layer or anchor layer or both a dielectric and anchor layer on one or more of the front and rear electrodes. One or more of N-propyltrimethoxysilane (SIP6918), hexadecyltrimethoxysilane (SIH5925), 3,3,3-trifluoropropyltrimethoxysilane (SIT8372), N-trimethoxysilylpropyl-N,N,N-trimethylammonium chloride (SIT8415), (tridecafluoro-1,1,2,2-tetrahydrooctyl)trimethoxysilane (SIT8176), octadecyldimethyl(3-trimethoxysilylpropyl)ammonium chloride (SIO6620.0), 3-(heptafluoroisopropoxy)propyltrimethoxysilane (SIH5842.2), (heptadecafluoro-1,1,2,2-tetrahydrodecyl)trimethoxysilane (SIH5841.5) or nonafluorohexyltrimethoxysilane (SIN6597.7) by Gelest, Inc. or 3-methacryloxypropyltrimethoxysilane (A714) by Momentive Performance Materials, Inc. or other similar molecular structures may then be attached or grafted onto the surface to create a bistability enhancement layer that holds the particles 120 to the surface to create a bistable display when power is off.

In an exemplary embodiment, the bistability layer may have a similar molecular structure as one or more of the surfactants or charge control agents in medium 118 and the coating on particles 120. This may promote bistability enhancement by surface-particle interactions.

In an exemplary application, display 100 operates in the following manner. When power is on, the applied voltage bias across medium 116 holds the particles 120 near the surface of electrode layers 110 and 114. This is shown in FIG. 1 where to the left of dotted line 124 particles 120 are held at power on at the rear electrode where there is no optional bistability enhancement layer. This creates a substantially stable bright or white state of the display where representative incident light ray 126 is totally internally reflected back towards viewer as reflected light ray 128. Alternatively, particles 120 may be held near front electrode 110 at power on to frustrate TIR and create a dark state of the display.

To the right of dotted line 124 particles 120 are held near the surface of the plurality of convex protrusions 108 and front electrode 110 when power is on. When power to the display is off the bistability enhancement layer 122 surface-particle interactions are able to hold the particles 120 in place near front electrode layer 110. This helps to substantially retain the image and create a bistable display. This substantially prevents particles from migrating away into the bulk of medium 118 and out of the evanescent wave region where TIR may be frustrated to create a light absorbing or dark state of the display. This effect is illustrated by representative incident light rays 130 and 132 that are absorbed by particles 120. As the particles 120 are held in place at power off near the front electrode 110 where total internal reflection is frustrated, this creates a dark state of the image display. The bistability layer may also enhance the bright state of the display by holding particles at the rear electrode which prevents the particles from migrating to the evanescent wave region and frustrating TIR.

In some embodiments, an optional bistability enhancement layer may be added to the top of rear electrode surface 114. The surface-particle interactions at the bistability enhancement layer may substantially prevent particles 120 located at the rear electrode from migrating into medium 118 and eventually to the front electrode where they may frustrate TIR and degrade the white state.

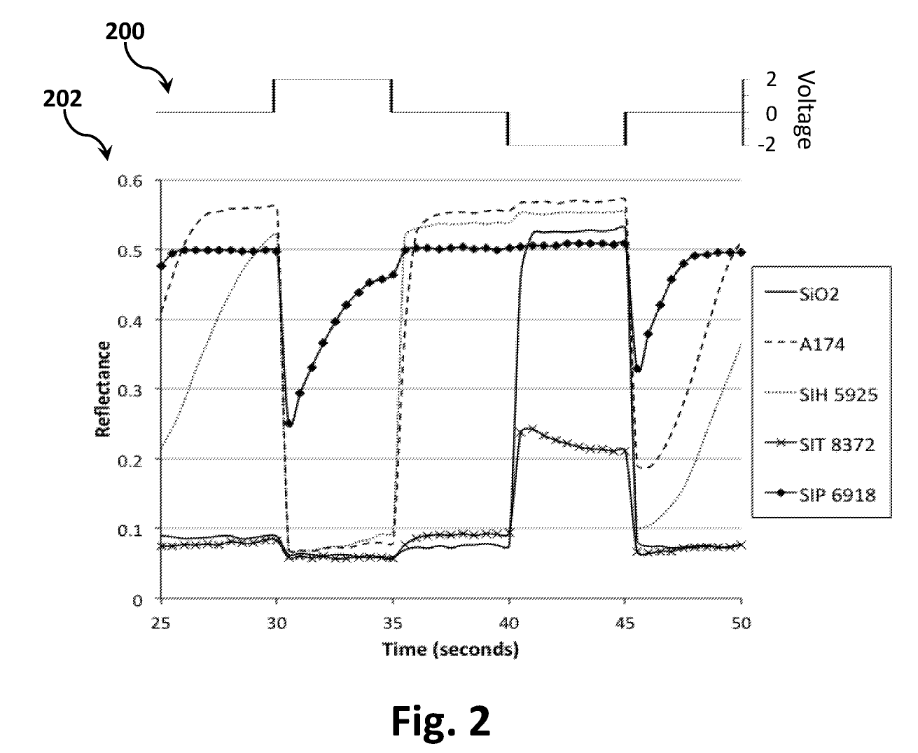

FIG. 2 is a graphical representation of a TIR image display with a bistability enhancing layer during switching. In FIG. 2, driving voltage profile 200 is illustrated where the x-axis is the bias driving time in seconds and the y-axis on the right side is the driving voltage applied to the rear electrode. The front electrode is connected to the ground. They-axis on the left side in plot 202 is the optical reflectance. The reflectance of each sample over time was recorded continuously while the voltage on the rear electrode was switched in a stepwise manner from 0V to +2V, to 0V, to −2V, and back to 0V (This is one complete cycle) to electrophoretically move the particles 120 (FIG. 1) between the front and rear electrodes in a fluorocarbon-based medium. Each voltage step was held for 5 seconds.

Five samples were tested with each having a different composition. The first sample labeled “SiO2” in FIG. 2 comprises a layer of SiO₂ dielectric on both the front and rear electrodes with a thickness of about 50 nm. Sample “SiO2” also acts as the bistability enhancement particle interaction layer. The second sample labeled “A174” comprises a dielectric layer of SiO₂ of about 50 nm on both the front and rear electrodes along with a layer of 3-methacryloxypropyltrimethoxysilane grafted onto each of the SiO₂ layers. The third sample labeled “SIH5925” comprises a dielectric layer of SiO₂ of about 50 nm on both the front and rear electrodes along with a layer of hexadecyltrimethoxysilane grafted onto each of the SiO₂ layers. The fourth sample labeled “SIT8372” comprises a dielectric layer of SiO₂ of about 50 nm on both the front and rear electrodes along with a layer of 3,3,3-trifluoropropyltrimethoxysilane grafted onto each of the SiO₂ layers. Lastly, the fifth sample labeled “SIP6918” comprises a dielectric layer of SiO₂ of about 50 nm on both the front and rear electrodes along with a layer of N-propyltrimethoxysilane grafted onto each of the SiO₂ layers.

FIG. 2 illustrates the optical response of one complete driving cycle that starts at time 30 s and ends at 50 s. Before time 30 s the reflectance values of the SIH5925 (dotted line) and A174 (dashed line) curves were >50% while the SiO₂ (solid line) and SIT8372 (-x-) curves were <10%. Quickly after the rear electrode was switched to +2V at time 30 s, all reflectance values dropped to <10%. This suggests that the positively charged particles were moved to the front electrode by the applied voltage bias of −2V. The SIP6918 (-♦-) sample was not stable and reached a reflectance value of about 20% only temporarily. This appeared as a dark gray color to the viewer. Overall the SIP6918 sample exhibited poor performance throughout the test.

When the rear electrode was switched to 0V at time 35 s, the SIH5925 and A174 curves returned to >50% reflectance almost instantaneously. This indicates that the particles moved away from the front electrode. In contrast the reflectance values of SiO₂ and SIT8372 remained at the same level at <10%, which indicates the particles were retained at the front electrode at 0V. At time 40 s when the rear electrode was switched to −2V, the reflectance of the SiO₂ sample reached >50%. This indicates substantially all of the positively charged particles moved away from the front electrode with a voltage bias of +2V. The SIT8372 sample reached a reflectance of only about 20%, which indicates that only a fraction of the particles were removed from the front electrode by the applied bias.

Based on the polarity of the silane molecules grafted onto the SiO₂ surface, the relative electronegativity level of the surface should follow the order of: SIP6918<SIH5925<A174<SiO₂<SIT8372. The ability of the cell to hold particles near to the dielectric layer located on the front electrode at power off appears to correlate well with the polarity level. The particles could not be pushed close enough to the front electrode with the layer containing SIP6918 by the voltage bias. The cell containing layers of SIH5925 and A174 remained near the front electrode surface only when the driving voltage was maintained (power on). The particles in the cell with only the SiO₂ layer acting as the dielectric and bistability enhancement particle interaction layer remain at the surface when the voltage is removed. The particles in the cell with the SIT8372 layer were held tightly to the SIT8372 layer on the front electrode layer and could not be moved away by a 2V bias at the front electrode.

Based on the graphical data in FIG. 2, the strength of the particle-surface interactions may be controlled and tuned by modifying the bistability enhancement layer near the evanescent wave region. As the data suggests, one method of doing this may be to control the polarity of the layer or polarity of pendant groups covalently bonded to the bistability enhancement layer.

It should be noted that it is important to control the amount or concentration of the electrophoretically mobile particles 120 suspended in medium 118. The bistability enhancement particle interaction layer is a two-dimensional surface that interacts with the particles that create a two-dimensional layer when attracted to the particle interaction layer. If the concentration is too high, particles that are not able to interact with the particle interaction layer 122 may drift or diffuse away from the surface at power off and into medium 118. As a result, particles 120 may move to undesirable locations within cavity 116 reducing image quality and long-term display performance. If the particle concentration is too low, there may not be enough particles to adequately frustrate total internal reflection when needed leading to insufficient dark states. In some embodiments, the particles may comprise a surface that is attractive to adjacent particles limiting the diffusion of particles away from the layer of particles interacting with the bistability enhancement layer.

If the particle density is kept at a minimum necessary for optimal display optical performance, an additional benefit of the invention may be observed. This benefit may also lead to bistability. This may occur when the particles have been moved adjacent and densified at an electrode layer. For low particle density, the bulk material behind the densified surface layers are being depleted of the particles (which takes appreciable time). This depletion may also denude the area of charge, which slows down the redistribution of packed particles on the surface when the power is turned off to the display. This may result in image stability.

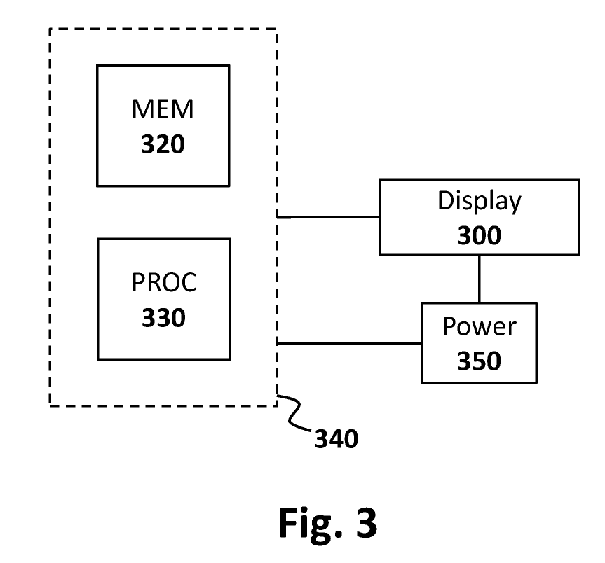

FIG. 3 shows an exemplary system for controlling a display according to one embodiment of the disclosure. In FIG. 3, display 300 is controlled by controller 340 having processor 330 and memory 320. Other control mechanisms and/or devices may be included in controller 340 without departing from the disclosed principles. Controller 340 may define hardware, software or a combination of hardware and software. For example, controller 340 may define a processor programmed with instructions (e.g., firmware). Processor 330 may be an actual processor or a virtual processor. Similarly, memory 320 may be an actual memory (i.e., hardware) or virtual memory (i.e., software).

Memory 320 may store instructions to be executed by processor 330 for driving display 300. The instructions may be configured to operate display 300. In one embodiment, the instructions may include biasing electrodes associated with display 300 (not shown) through power supply 350. When biased, the electrodes may cause movement of electrophoretic particles towards or away from a region proximal to the surface of the plurality of convex protrusions at the inward surface of the front transparent sheet to thereby absorb or reflect light received at the inward surface of the front transparent sheet. By appropriately biasing the electrodes, particles (e.g., particles 120 in FIG. 1) may be moved near the surface of the plurality of protrusions at the inward surface of the front transparent sheet into or near the evanescent wave region in order to substantially or selectively absorb or reflect the incoming light. Absorbing the incoming light creates a dark or colored state. By appropriately biasing the electrodes, particles (e.g., particles 120 in FIG. 1) may be moved away from the surface of the plurality of protrusions at the inward surface of the front transparent sheet and out of the evanescent wave region in order to reflect or absorb the incoming light. Reflecting the incoming light creates a light state.

In some embodiments, any of the reflective image displays comprising a bistability enhancement layer described herein may further include at least one sidewall (may also be referred to as cross-walls). Sidewalls limit particle settling, drift and diffusion to improve display performance and bistability. Sidewalls may be located within the light modulation layer comprising the particles and medium. Sidewalls may completely or partially extend from the front electrode, rear electrode or both the front and rear electrodes. Sidewalls may comprise plastic, metal or glass or a combination thereof. Sidewalls may create wells or compartments (not shown) to confine the electrophoretically mobile particles. The sidewalls or cross-walls may be configured to create wells or compartments in, for example, square-like, triangular, pentagonal or hexagonal shapes or a combination thereof. The walls may comprise a polymeric material and patterned by conventional techniques including photolithography, embossing or molding. The walls help to confine the mobile particles to prevent settling and migration of said particles that may lead to poor display performance over time. In certain embodiments the displays may comprise cross-walls that completely bridge the gap created by the front and rear electrodes in the region where the air or liquid medium and the electrophoretically mobile particles reside. In certain embodiments, the reflective image display described herein may comprise partial cross-walls that only partially bridge the gap created by the front and rear electrodes in the region where the air or liquid medium and the mobile particles reside. In certain embodiments, the reflective image displays described herein may further comprise a combination of cross-walls and partial cross-walls that may completely and partially bridge the gap created by the front and rear electrodes in the region where the medium and the electrophoretically mobile particles reside.

In some embodiments, any of the reflective image displays comprising a bistability enhancement layer described herein may further comprise a color filter array layer. The color filter array layer may comprise at least one or more of red, green and blue or cyan, magenta and yellow filters.

In some embodiments, any of the reflective image displays comprising a bistability enhancement layer described herein may further comprise a directional front light system. The directional front light system may include a light source, light guide and an array of light extractor elements on the outward surface of the front sheet in each display. The directional light system may be positioned between the outward surface of the front sheet and the viewer. The front light source may define a light emitting diode (LED), cold cathode fluorescent lamp (CCFL) or a surface mount technology (SMT) incandescent lamp. The light guide may be configured to direct light to the front entire surface of the transparent outer sheet while the light extractor elements direct the light in a perpendicular direction within a narrow angle, for example, centered about a 30° cone, towards the front sheet. A directional front light system may be used in combination with cross-walls or a color filter layer in the display architectures described herein or a combination thereof.

In some embodiments, any of the reflective image displays comprising a bistability enhancement layer described herein may further include at least one edge seal. An edge seal may be a thermally or photo-chemically cured material. The edge seal may comprise one or more of an epoxy, silicone or other polymer based material.

In other embodiments, any of the reflective image displays comprising a bistability enhancement layer described herein may further include a light diffusive layer to “soften” the reflected light observed by the viewer. In other embodiments a light diffusive layer may be used in combination with a front light.

In other embodiments, any of the reflective image displays comprising a bistability enhancement layer described herein may further include at least one spacer unit. The at least one spacer unit may control the spacing of the gap or cavity between the front and rear sheets. The spacer structures may be in the shape of one or more of circular or oval beads, blocks, cylinders or other geometrical shapes. The spacer structures may be comprised of one or more of plastic or glass.

It should be noted that although the focus of the display invention herein is with TIR-based displays, the invention may also be used in reflective image displays that are not TIR displays. Such displays may be those that are absent of convex protrusions on the front sheet.

In the display embodiments described herein, they may be used in applications such as in, but not limited to, electronic book readers, portable computers, tablet computers, cellular telephones, smart cards, signs, watches, wearables, shelf labels, flash drives and outdoor billboards or outdoor signs comprising a display. The displays may be powered by one or more of a battery, solar cell, wind, electrical generator, electrical outlet, AC power, DC power or other means.

The following exemplary and non-limiting embodiments provide various implementations of the disclosure. Example 1 relates to a reflective image display device capable of retaining an image at power off state, the display comprising: an optically transparent sheet having a surface comprising a plurality of convex protrusions on an inward surface; a front electrode; a rear electrode; a medium contained between the front and rear electrodes; at least one charged electrophoretically mobile particle suspended within the medium; a bistability enhancement layer; and a voltage source for applying a voltage bias across the medium to form an electromagnetic field therebetween the front and rear electrodes to move the at least one electrophoretically mobile particle.

Example 2 relates to the image display device of example 1, further comprising one or more dielectric layers.

Example 3 relates to the image display device of example 2, wherein the one or more dielectric layers is SiO₂.

Example 4 relates to the image display device of example 1, wherein the bistability enhancement layer comprises at least one organosilane group.

Example 5 relates to the image display device of example 1, wherein the bistability enhancement layer also acts as a dielectric layer.

Example 6 relates to the image display device of examples 1 or 2, further comprising a directional front light.

Example 7 relates to the image display device of example 1, further comprising a color filter layer.

Example 8 relates to the image display device of example 1, further comprising an edge seal.

Example 9 relates to the image display device of example 1, further comprising a spacer structure.

Example 10 relates to the image display device of example 1, wherein the rear electrode is a direct drive patterned array, thin film transistor array or a passive matrix array.

Example 11 relates to a tangible machine-readable non-transitory storage medium that contains instructions may be used in combination with the display described herein that includes a particle interaction layer. When executed by one or more processors results in performing the operations comprising: positioning at least one charged electrophoretic particle in a transparent medium disposed between a pair of opposing electrodes of an electrode pair; biasing each electrode of the electrode pair with an initial voltage bias to form an electromagnetic field therebetween to attract the at least one charged electrophoretic particle to the front electrode or the rear electrode of the electrode pair; and providing retaining the image in the display at 0V or power off to thereby prevent movement of the at least one charged electrophoretic particle from one electrode of the electrode pair to the second electrode of the electrode pair.

Example 12 relates to a tangible machine-readable non-transitory storage medium of example 11, wherein the step of biasing each electrode further comprises biasing each of the front electrode and the rear electrode to substantially the same voltage bias.

Example 13 relates to a tangible machine-readable non-transitory storage medium of example 11, wherein the step of biasing each electrode further comprises biasing each of the front electrode and the rear electrode to different voltage biases.

Example 14 relates to a tangible machine-readable non-transitory storage medium of example 11, wherein the step of biasing each electrode further comprises forming a voltage gradient between the front electrode and the rear electrode.

Example 15 relates to a tangible machine-readable non-transitory storage medium of example 11, wherein the step of biasing each electrode further comprises modulating the movement of the at least one electrophoretic particle between the front and rear electrode.

While the principles of the disclosure have been illustrated in relation to the exemplary embodiments shown herein, the principles of the disclosure are not limited thereto and include any modification, variation or permutation thereof.

1-15. (canceled)

16. A reflective image display device capable of retaining an image at power off state, the display comprising:
an optically transparent sheet having a surface comprising a plurality of convex protrusions on an inward surface;
a front electrode;
a rear electrode;
a medium contained between the front and rear electrodes;
at least one charged electrophoretically mobile particle suspended within the medium;
a bistability enhancement layer; and
a voltage source for applying a voltage bias across the medium to form an electromagnetic field therebetween the front and rear electrodes to move the at least one electrophoretically mobile particle.

17. The image display device according to claim 16, further comprising one or more dielectric layers.

18. The image display device according to claim 17, wherein the one or more dielectric layers is SiO₂.

19. The image display device according to claim 16, wherein the bistability enhancement layer comprises at least one organosilane group.

20. The image display device according to claim 16, wherein the bistability enhancement layer also acts as a dielectric layer.

21. The image display device according to claim 16, further comprising a directional front light.

22. The image display device according to claim 16, further comprising a color filter layer.

23. The image display device according to claim 16, further comprising an edge seal.

24. The image display device according to claim 16, further comprising a spacer structure.

25. The image display device according to claim 16, wherein the rear electrode is a direct drive patterned array, thin film transistor array or a passive matrix array.

26. A tangible machine-readable non-transitory storage medium that contains instructions may be used in combination with the display described herein that includes a particle interaction layer. When executed by one or more processors results in performing the operations comprising:
positioning at least one charged electrophoretic particle in a transparent medium disposed between a pair of opposing electrodes of an electrode pair;
biasing each electrode of the electrode pair with an initial voltage bias to form an electromagnetic field therebetween to attract the at least one charged electrophoretic particle to the front electrode or the rear electrode of the electrode pair; and
providing retaining the image in the display at 0V or power off to thereby prevent movement of the at least one charged electrophoretic particle from one electrode of the electrode pair to the second electrode of the electrode pair.

27. The tangible machine-readable non-transitory storage medium of claim 26, wherein the step of biasing each electrode further comprises biasing each of the front electrode and the rear electrode to substantially the same voltage bias.

28. The tangible machine-readable non-transitory storage medium of claim 26, wherein the step of biasing each electrode further comprises biasing each of the front electrode and the rear electrode to different voltage biases.

29. The tangible machine-readable non-transitory storage medium of claim 26, wherein the step of biasing each electrode further comprises forming a voltage gradient between the front electrode and the rear electrode.

30. The tangible machine-readable non-transitory storage medium of claim 26, wherein the step of biasing each electrode further comprises modulating the movement of the at least one electrophoretic particle between the front and rear electrode.
